(19) United States
(12) Patent Application Publication
(10) Pub. No.: US 2006/0030257 A1
(43) Pub. Date: Feb. 9, 2006

(54) Integral environmental monitor

(76) Inventor: Christian L. Belady, Richardson, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/899,752

(22) Filed: Jul. 26, 2004

(51) Int. Cl. B01L 1/04

(52) U.S. Cl. 454/187

(57) ABSTRACT

An enclosure having a front and back and including at least one environmental parameter detector is built. The environmental parameter detector is electrically coupled with a display mechanically attached to the front or back of the enclosure. The display may be programmed to show a variety of environmental parameters from the at least one environmental parameter detectors inside the enclosure. An optional alarm may be mechanically attached to the enclosure configured to activate when one or more of the environmental parameters exceeds their defined margin.

### FIELD OF THE INVENTION

The present invention relates generally to the field of enclosures, and more particularly to the field of enclosures including environmental monitors.

### BACKGROUND OF THE INVENTION

As electronic devices increase in speed and power consumption, cooling these devices becomes critical to their proper operation. Particularly when placed inside enclosures, which may modify the natural airflow around the device, proper cooling device operation is critical. While air temperature within the enclosure is a very critical environmental factor for the electronic devices within the enclosure, other environmental factors such as humidity, air pressure, and air velocity may be critical to the proper operation of the electronic devices.

### SUMMARY OF THE INVENTION

An enclosure having a front and back and including at least one environmental parameter detector is built. The environmental parameter detector is electrically coupled with a display mechanically attached to the front or back of the enclosure. The display may be programmed to show a variety of environmental parameters from the at least one environmental parameter detectors inside the enclosure. An optional alarm may be mechanically attached to the enclosure configured to activate when one or more of the environmental parameters exceeds their defined margin.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1 is a view of an enclosure including a front door with an integral environmental monitor according to the present invention.

FIG. 2 is a view of an enclosure including a back door with an integral environmental monitor according to the present invention.

FIG. 3 is a flow chart of a method for constructing an enclosure with an integral environmental monitor according to the present invention.

### DETAILED DESCRIPTION

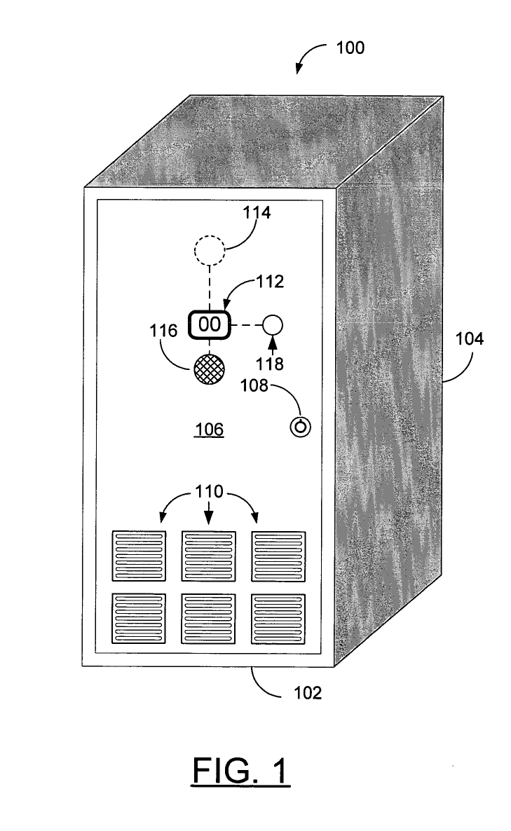

FIG. 1 is a view of an enclosure including a front door with an integral environmental monitor according to the present invention. In the example embodiment of the present invention shown in FIG. 1, an enclosure 100 having a front 102 and a back 104 is shown including a front door 106. Some example embodiments of the present invention will not have a front door 106, but simply have a non-opening front 102 of the enclosure. The front door 106 includes a latch 108, a plurality of fans 110, a display 112, at least one environmental parameter sensor 114, and an optional alarm 116. The environmental parameter sensors 114 may determine environmental conditions within the enclosure 100 such as temperature, relative humidity, air pressure, air velocity, or any other environmental condition desired to be monitored within the scope of the present invention. The display 112 may be a LCD, a LED, or any other display capable of displaying environmental parameter information within the scope of the present invention. Those of skill in the art will recognize that while the environmental parameter sensors 114 in this example embodiment are placed on the front door 106 they may be placed anywhere within the enclosure within the scope of the present invention. Likewise, while the alarm 116 is shown mechanically attached to the front door 106 it may be placed anywhere desired, including at a remote location distant from the enclosure 100 within the scope of the present invention. Also, while the display 112 is shown mechanically attached to the front door 106 it may be placed anywhere on the enclosure 100 or may be placed at a remote location distant from the enclosure 100 within the scope of the present invention. By placing the display 112 on the actual enclosure 100, environmental information will be available to people responsible for environmental conditions in a data center without the need to go to a control terminal and without the need for any kind of a user account on any of the computers contained within the enclosure. Also, optionally, a control 118 may be added to control what information is shown on the display 112. This control 118 allows the display 112 to perform a plurality of functions such as displaying a computer address or other information along with a plurality of environmental information.

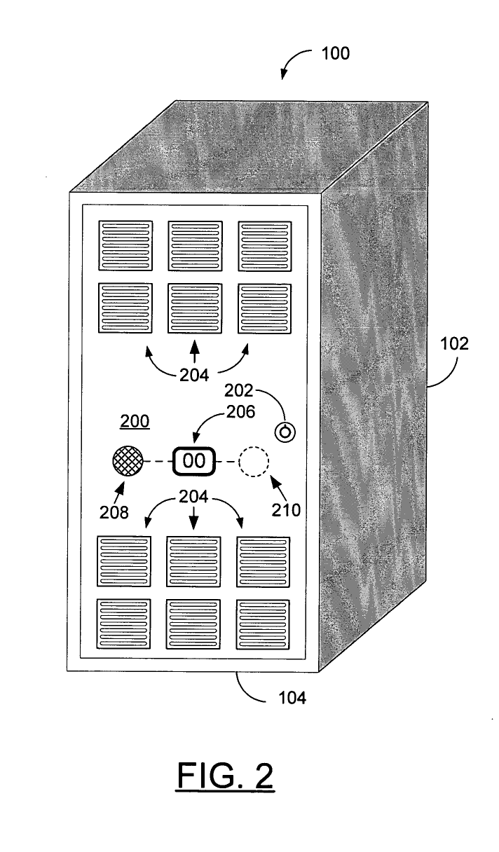

FIG. 2 is a view of an enclosure including a back door with an integral environmental monitor according to the present invention. In the example embodiment of the present invention shown in FIG. 2, an enclosure 100 having a front 102 and a back 104 is shown including a back door 200. Some example embodiments of the present invention will not have a back door 200, but simply have a non-opening back 104 of the enclosure. The back door 200 includes a latch 202, a plurality of fans 204, a display 206, at least one environmental parameter sensor 210, and an optional alarm 208. The environmental parameter sensors 210 may determine environmental conditions within the enclosure 100 such as temperature, relative humidity, air pressure, air velocity, or any other environmental condition desired to be monitored within the scope of the present invention. The display 206 may be a LCD, a LED, or any other display capable of displaying environmental parameter information within the scope of the present invention. Those of skill in the art will recognize that while the environmental parameter sensors 210 in this example embodiment are placed on the back door 200 they may be placed anywhere within the enclosure within the scope of the present invention. Likewise, while the alarm 208 is shown mechanically attached to the back door 200 it may be placed anywhere desired, including at a remote location distant from the enclosure 100 within the scope of the present invention. Also, while the display 206 is shown mechanically attached to the back door 200 it may be placed anywhere on the enclosure 100 or may be placed at a remote location distant from the enclosure 100 within the scope of the present invention.

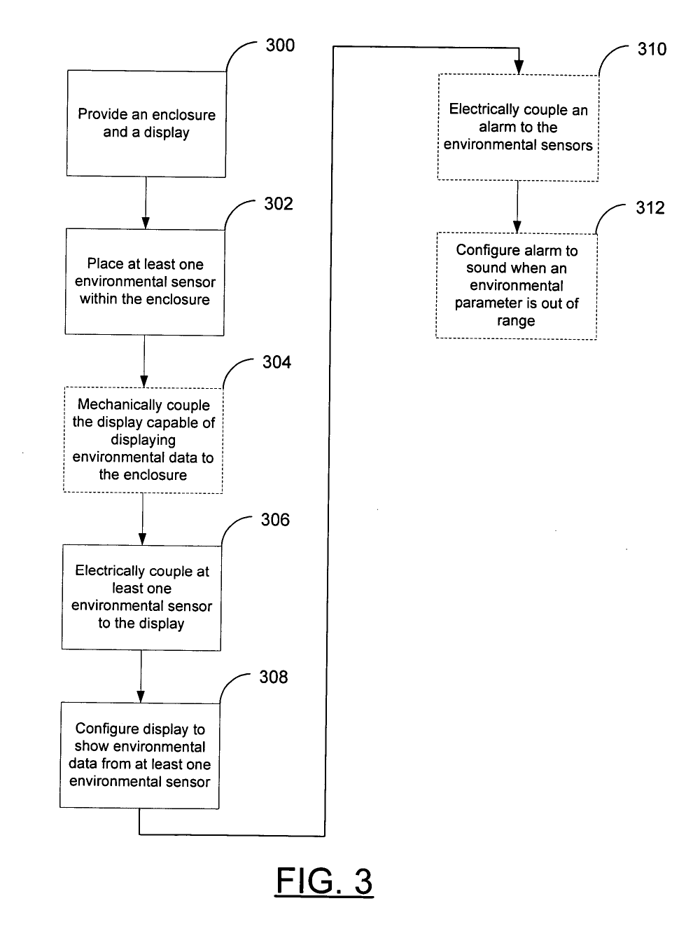

FIG. 3 is a flow chart of a method for constructing an enclosure with an integral environmental monitor according to the present invention. In a step 300, an enclosure and a display are provided. In a step 302, at least one environmental parameter sensor is placed within the enclosure. In an optional step 304, a display capable of displaying environmental data is mechanically coupled to the environmental parameter sensors. As discussed above, the location of this display may be anywhere desired within the scope of the present invention. In a step 306, the environmental parameter sensors are electrically coupled to the display. In a step 308, the display is configured to show environmental data from the environmental parameter sensors. In an optional step 310, an alarm is electrically coupled to the environmental parameter sensors. In an optional step 312, the alarm is configured to sound when an environmental parameter is found to be out of range.

The foregoing description of the present invention has been presented for purposes of illustration and description. It is not intended to be exhaustive or to limit the invention to the precise form disclosed, and other modifications and variations may be possible in light of the above teachings. The embodiments were chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A device comprising:
an enclosure;
at least one environmental parameter sensor placed within said enclosure; and
a display configured to display environmental data electrically coupled to said at least one environmental parameter sensor.

2. A device as recited in claim 1,
wherein one of said at least one environmental parameter sensor detects temperature.

3. A device as recited in claim 1,
wherein one of said at least one environmental parameter sensor detects relative humidity.

4. A device as recited in claim 1,
wherein one of said at least one environmental parameter sensor detects air pressure.

5. A device as recited in claim 1,
wherein one of said at least one environmental parameter sensor detects air velocity.

6. A device as recited in claim 1,
wherein said display is mechanically coupled to said enclosure.

7. A device as recited in claim 1,
wherein said environmental parameter sensor is mechanically coupled to said enclosure.

8. A device as recited in claim 1, further comprising:
an alarm electrically coupled to said at least one environmental parameter sensor.

9. A device as recited in claim 8,
wherein said alarm is configured to sound when an environmental parameter is out of a specified range.

10. A device as recited in claim 8,
wherein said alarm is mechanically coupled to said enclosure.

11. A device as recited in claim 1, further comprising:
a control electrically coupled to said display, configured to change a function of said display.

12. A device as recited in claim 11:
wherein said control is mechanically coupled to said enclosure.

13. A method comprising the steps of:
a) providing an enclosure;
b) providing a display;
c) placing at least one environmental parameter sensor within the enclosure;
d) electrically coupling the display to the at least one environmental parameter sensor;
e) configuring the display to show environmental data from the at least one environmental parameter sensor.

14. A method as recited in claim 13,
wherein one of said at least one environmental parameter sensor detects temperature.

15. A method as recited in claim 13,
wherein one of said at least one environmental parameter sensor detects temperature.

16. A method as recited in claim 13,
wherein one of said at least one environmental parameter sensor detects temperature.

17. A method as recited in claim 13,
wherein one of said at least one environmental parameter sensor detects relative humidity.

18. A method as recited in claim 13,
wherein one of said at least one environmental parameter sensor detects air pressure.

19. A method as recited in claim 13,
wherein one of said at least one environmental parameter sensor detects air velocity.

20. A method as recited in claim 13, further comprising the step of:
f) mechanically coupling the display to the enclosure.

21. A method as recited in claim 13, further comprising the step of:
f) mechanically coupling the at least one environmental parameter sensor to the enclosure.

22. A method as recited in claim 13, further comprising the steps of:
f) providing an alarm;
g) electrically coupling the alarm to the at least one environmental parameter sensor.

23. A method as recited in claim 22, further comprising the step of:
h) configuring the alarm to sound when an environmental parameter is out of a defined range.

24. A method as recited in claim 22, further comprising the step of:
h) mechanically coupling the alarm to the enclosure.

25. A method as recited in claim 13, further comprising the step of:
f) electrically coupling a control to the display; and
g) configuring the control to change a function of the display.

26. A method as recited in claim 25, further comprising the step of:
h) mechanically coupling the control to the enclosure.
